(19) United States
(12) Patent Application Publication
(10) Pub. No.: US 2012/0101906 A1
(43) Pub. Date: Apr. 26, 2012

(54) METHOD AND SYSTEM FOR PRINTING INFORMATION RELATED TO INTERNET ADVERTISEMENTS

(75) Inventors: Mark David Jacobson, Denver, CO (US); Tyler Reece Stuart, Denver, CO (US)

(73) Assignee: FORMAT DYNAMICS LLC, Denver, CO (US)

(21) Appl. No.: 13/294,454

(22) Filed: Nov. 11, 2011

Related U.S. Application Data
(63) Continuation of application No. 11/552,002, filed on Oct. 23, 2006, now abandoned.
Application No. 11/552,002 is a continuation-in-part of application No. 10/948,798, filed on Sep. 24, 2004, now Pat. No. 7,386,791.
(60) Provisional application No. 60/505,960, filed on Sep. 24, 2003.
(60) Provisional application No. 60/505,956, filed on Sep. 24, 2003.

(51) Int. Cl. G06Q 30/02

(52) U.S. Cl. 705/14.72

(57) ABSTRACT

A method and system for placing an excitable icon in or next to a screen Internet advertisement offering users the ability to print information related to the advertised product or service, which could consist of, but is not limited to, a marketing brochure or coupon. The method and system performs these tasks without noticeably altering the appearance of the web page on which the screen Internet advertisement and button are placed, opening a new browser window for the information to be displayed or redirecting the browser to the advertiser's web page.

### CROSS REFERENCE TO RELATED APPLICATIONS

The present application is a continuation of U.S. patent application Ser. No. 11/552,002, filed 23 Oct. 2006, which is a continuation-in-part of U.S. patent application Ser. No. 10/948,798, filed Sep. 24, 2004, now U.S. Pat. No. 7,386,791, issued 10 Jun. 2008, which claims priority to U.S. Provisional Patent Application No. 60/505,960, filed 23 Sep. 2003, and U.S. Provisional Patent Application No. 60/505,956, filed 23 Sep. 2003, the disclosures of which are hereby incorporated in their entirety by reference.

### BACKGROUND OF THE INVENTION

1. Field of the Invention

The present invention relates to data processing systems, methods and computer program products for delivering and formatting information.

2. Description of Related Art

The Internet includes a vast number of computers and computer networks that are interconnected through communication links. The interconnected computers exchange information using various services, such as a computer network, electronic mail, Gopher, and the World Wide Web (WWW). The Internet allows a server computer to send web pages containing Internet advertisements to a user system. That user system can then display, via a browser, the web pages including the Internet advertisements on a display screen included in, or attached to, the user system. To view a specific web page, a user system and the browser specify the Universal Resource Indicator (URI) for that document in a request, which can include a Hypertext Transfer Protocol (HTTP) request; that request is then forwarded to the server computer that supports provisioning of that web page. When that server computer receives the request, it sends that document to the user system. Subsequently, when the user system receives the requested web page, it typically displays the document in cooperation with the browser. Each screen advertisement to be displayed on the web page is either requested and sent to the user system from the same server system as the web page or is requested, using URI links in the code of the web page, from one or more remote server systems or server systems.

Typically, web pages are defined using code, which provides a standard set of instructions or tags that define how a web page is to be displayed. This code is typically source code or object code which can include, but is not limited to, Hypertext Markup Language (HTML), eXtensible Markup Language (XML), Dynamic Hypertext Markup Language (DHTML), Java and JavaScript. Thus, when, as above, a user requests the browser to initiate display of a web page, the browser sends a request to the server computer to transfer to the user system the code that defines the web page. When the requested code for the web page is received by the user system, the browser then displays the document in a layout defined by the code. That code contains various tags or instructions that control the layout (i.e., the arrangement of text, graphics, icons (e.g., providing activation of specific tools such as print or electronic mail), images and graphical representations of URI links for obtaining other documents available on that server computer or other server computers (e.g., navigational URI links) and advertisements (i.e., screen advertisements).

Although some publishers receive revenue selling subscriptions to view their web pages, the vast majority of publishers receive revenue by selling space for the placement of screen advertising content. Such revenue can be obtained, for example, whenever a web page containing screen advertising content is requested or, in some instances, whenever a user activates screen advertising content; requesting the advertiser's web page to be displayed on the user's display device. Most screen advertising content is designed to be activated by a user, which activation may open a new window containing the advertiser's web page or replace the existing web page with the advertiser's web page. Contrarily, a user will typically request and view the original web page for a specific reason (e.g., to read an article, research a product, or obtain driving directions) and does not want to be redirected to an advertiser's web page at that moment (i.e., diverting them from their current task).

### SUMMARY OF THE INVENTION

In accordance with at least one embodiment of the invention a method is provided for Internet advertisers to potentially make their advertisements more effective by allowing users to send print advertising content (e.g., product information, brochures, coupons) to a printing device, instead of diverting the user from their current task or visibly altering the web page currently displayed on the display screen in order for the user to obtain additional information.

In addition, in accordance with at least one embodiment of the invention, a method for creating Print Advertising Content (“PAC”) is provided, creating and inserting a print PAC icon on or next to associated Screen Advertising Content (“SAC”), and creating and implementing Printing Machine Executable Instructions (“PMEI”) which instructs the RRRC (defined below) what to due if there is a Print activation event. Such operations may enable potential distribution of a SAC by an advertiser for display on web pages downloaded by users of one, or more, web sites. Conventional SAC are associated with specific URIs which, when activated, call the advertisers web pages associated with the URIs. Such web pages typically either replace the web page the user is currently viewing or are displayed in a new window placed in front of the web page the user is viewing. In either instance, the user is diverted from their current task (e.g., reading an article, obtaining driving directions, researching a product, etc.) in order to gain additional information regarding the product or service being advertised via the SAC.

Further, in accordance with at least one embodiment of the invention, a method and system offer another option for users to receive additional (e.g., printed) information related to an SAC without “calling” the advertiser's web page or diverting them from their current task by placing a print PAC button on or next to SAC displayed on a web page. If a user is interested in obtaining the PAC associated with the SAC then they only need to activate the print PAC button. As a result of that Print activation event, the PMEI associated with the SAC automatically requests, receives, and renders in a print medium the PAC without noticeably altering the appearance of the web page rendered on the display device.

### BRIEF DESCRIPTION OF THE DRAWINGS

Embodiments of the invention are described, by way of example only, with reference to the accompanying schematic drawings in which corresponding reference symbols indicate corresponding parts, and in which:

FIG. 1 shows a schematic representation of the current environment in which a web page is requested and received by the RRRC of a user system and rendered on a viewing screen. Such web page contains either SAC or URI links to obtain such SAC.

FIG. 2 illustrates an example of a conventional web page containing SAC that can be downloaded by a user system via a communication network for display on a display device.

FIG. 3 illustrates an advertiser's web page which is traditionally requested and rendered on a user's viewing device upon the excitation of the associated SAC.

FIG. 4 shows a schematic representation of an environment in which various embodiments of the invention are implemented.

FIG. 5 illustrates the web page of FIG. 2 with at least one print PAC button placed in or next to an associated SAC.

FIG. 6 illustrates two pages of PAC as rendered by a printing device upon a user activating a print PAC button placed in or next to the associated SAC.

FIG. 7 illustrates operations associated with various embodiments of the invention.

FIG. 8 illustrates an example of an unrelated publisher's web page which contains example SAC purchased by an example advertiser for display on the web page.

FIG. 9 illustrates example SAC with a print PAC button positioned on the SAC.

FIG. 10 illustrates an example PAC which would be printed upon a PAC activation event by a user exciting the print PAC button on the example SAC.

FIG. 11 illustrates two examples of content which may be used to create the example PAC. Such illustrations are not meant to limit the type or quantity of information which can be used to create the example PAC.

FIG. 12 illustrates an example of an advertiser's web page which the user is redirected to upon activating the example SAC instead of the print PAC button.

FIG. 13 includes one example format of a data report generated by a rendering tracker component provided in accordance with the second embodiment of the invention.

### DETAILED DESCRIPTION OF EMBODIMENTS

Providing an alternative method for a user to obtain additional information on a product or service advertised via screen advertising content without distracting the user or redirecting them to a new web page can potentially increase the effectiveness of the screen advertising content. This method can place printed product information or coupons in front of interested users who do not want to be redirected from the existing web page and, for this reason, would not traditionally activate the screen advertising content.

Further, screen advertising content is conventionally designed for the attributes of a display device and are, in most cases, meant to be activated e.g., clicked on. Since only a small percentage of screen advertising content is actually activated, the advertiser has very limited space on the webpage to promote their product or service. Because many users do not want to be diverted from their existing task on a web page, they choose not to activate the onscreen advertising content.

Further, conventionally, if a user elects to print a web page containing screen advertising content, the resulting printed information does very little for the advertiser as, in most cases, screen advertising content does not optimally take advantage of the attributes of the printed page (e.g., it is impossible to activate screen advertising content represented on the printed page). In addition, as most modern screen advertising content utilizes multiple frames of information, when a user prints a web page only the single frame of the advertisement visible on the display device when the user activated the print will appear on the printed page. This printed frame often does not display the name of the company, product, or service being advertised.

Traditional Internet advertisers can potentially make their advertisements more effective by allowing users to send print advertising content (e.g., product information, brochures, and coupons) to their printing device for later review, instead of diverting the user from their current task or visibly altering the web page currently displayed on the display screen.

Accordingly, various embodiments of the invention a method provide Internet advertisers with the opportunity to potentially make their advertisements more effective by allowing users to send print advertising content (e.g., product information, brochures, coupons) to a printing device, instead of diverting the user from their current task or visibly altering the web page currently displayed on the display screen in order for the user to obtain additional information.

Users typically request and receive web pages from publishers via the Internet to view the primary content of the web page (e.g., news articles, driving directions, shopping information, etc.). The vast majority of publishers makes such information available at no charge to the user and, instead, earns revenue by selling space on their web pages to advertisers of products and services. Such advertisers place SAC in such purchased space. The SAC may provide information on a product or service and are usually designed to influence the user into purchasing the advertised goods or services. Although the SAC does contain information related to the product or service being advertised, because of the limited space for information, a large portion of such SAC are designed to entice interested users to excite or activate the SAC in order to obtain additional information via the advertiser's web page.

Conventionally a user requested the original web page to view the content. However, a user is diverted from their original task if they desire additional information associated with the products or services advertised in the SAC. If the user were to have continued with their original task, the advertiser would have only been able to impact the user utilizing the SAC, which is placed in a relatively small space in the publisher's web page and must compete for the user's attention with the primary content and other SAC placed in the web page. Further, using conventional configurations, the advertiser's SAC is only visible for the length of time the user is viewing the web page.

A layout typically utilized for a web page often contains various types of content including both publisher content and advertiser content. The publisher content may include, for example, the main information of the web page (which could include, but is not limited to, text of an article of a news web page, driving directions of a mapping web page, or electronic mail text of an electronic mail web page), and additional content which could include, but is not limited to, the publisher's logo, navigational links, legal disclaimers, buttons activating various tools and screen advertising content. Screen advertising content is positioned in locations on the web page which were sold to the advertiser by the publisher. Such screen advertising content may include, but is not limited to, banner advertisements, rich media advertisements, animated gif advertisements, flash advertisements, video advertisements, search related advertisements, sponsorship advertisements, classified advertisements, etc. Conventionally, in the typical layout of a web page the content which includes, but is not limited to, pieces of publisher content such as a body (which may consist primarily of text) and various graphical items such as, but not limited to, a company logo, navigational URI links, user options, and a legal disclaimer. In addition the web page consists of various pieces of advertiser content such as screen advertising content. All of which is designed for and viewed on a user's display device. Since it was designed for rendering on a viewing device which often is wider than the average printer paper, many of the items (including screen advertising content) positioned on the right side of the viewing device are cut-off when sent to a print medium thereby making the screen advertising information impossible to view. As with all existing Internet advertising, screen advertising content is designed to draw the user's attention and provide as much information as necessary to interest the user into making a purchase or requesting additional information. Traditionally screen advertising content is designed for the user to activate the screen advertising content, which is impossible once the ad is on the printed page.

Traditionally, upon a user exciting screen advertising content, URI links associated with the screen advertising content instruct the user system to request, receive and render the advertiser's web page on the user's viewing device.

In accordance with various embodiments of the invention, a method is provided for creating a print PAC button (also referred to as an icon), explained herein, which is placed in or next to screen advertising content that dynamically, upon the activation or excitation of the print PAC button, requests, if not already obtained, receives and renders print advertising content associated with the screen advertising content positioned on the web page in a print medium. Once the print PAC button is activated, this process is completed without noticeably altering the appearance of the web page as rendered on the display device.

Throughout the further explanation of the embodiments of the invention, the term “screen advertising content,” or “SAC” as used herein, broadly refers to Internet advertisements purchased by advertisers and placed on Web pages. Such SAC may consist of all advertising sold by publishers, purchased by advertisers, and delivered to a user via the Internet. Examples of such advertising may include, but is not limited to, banner advertisements, rich media advertisements, animated gif advertisements, flash advertisements, video advertisements, search related advertisements, sponsorship advertisements, classified advertisements, etc.

Throughout the further explanation of the embodiments of the invention, the term “print advertising content,” or “PAC” as used herein, broadly refers to print advertising content which is associated with a corresponding SAC and is designed to be rendered in a print medium. Such PAC may include, but is not limited to, marketing collateral, product brochures, and redeemable coupons, all specifically designed for the print medium. The PAC may include one, or more, printed pages and given that in most cases it is printed on 8.5 inch by 11 inch paper, there is plenty of space for high resolution images and advertising copy. The PAC may be either included in the SAC, but not visible on the screen, or not included in the SAC when originally sent by the SAC provider to the user system (in which case, the PAC may be subsequently obtained by the PMEI via the RRRC from the SAC provider, the PAC provider, the publisher, the advertiser, or one or more remote sources. The PAC may then be sent to the user's printer upon a PAC activation event.

The term “print PAC button” broadly refers to an excitable icon which is placed in or next to an associated SAC and enables users to obtain PAC without noticeable altering the appearance of the web page rendered on the display device. The print PAC button may include instructions for obtaining and rendering PAC or URI links to obtain such PAC and deliver such information to a user's printing device.

The term “print machine executable instructions,” or “PMEI,” broadly refers to printing machine executable instructions (e.g., identifying which PAC is associated with a given SAC, how to obtain such PAC, if not already obtained, and how to render the information in a print medium), and may include instructions, if necessary, for altering part or all of the a web page (e.g., content, layout, SAC) on which the SAC is placed in response to a PAC activation event and may include instructions for obtaining and rendering PAC or URI links to obtain such PAC and deliver such information to a user's printer. The term “content” broadly refers to text, graphics, images and graphical representations of URI's of documents available on one or more server systems (e.g., navigational URI links), icons (e.g., providing access to specific tools), and/or PMEI icons (e.g., activation buttons to be used to trigger PAC activation events incorporated in the PMEI). The term “layout” broadly refers to the instructions for placement of content to be rendered on the display device.

Throughout the further explanation of the embodiments of the invention, the term “PAC activation event” broadly refers to a user activating or exciting a print PAC button with the intention of receiving PAC associated with the appropriate SAC via their printing device.

Furthermore, the term “web page” or “digital document” is meant to refer to, but not be limited to, web pages or digital documents residing on servers or server systems connected to a communication network, the Internet and web pages or digital documents residing on servers or server systems connected to an Intranet and/or Extranet.

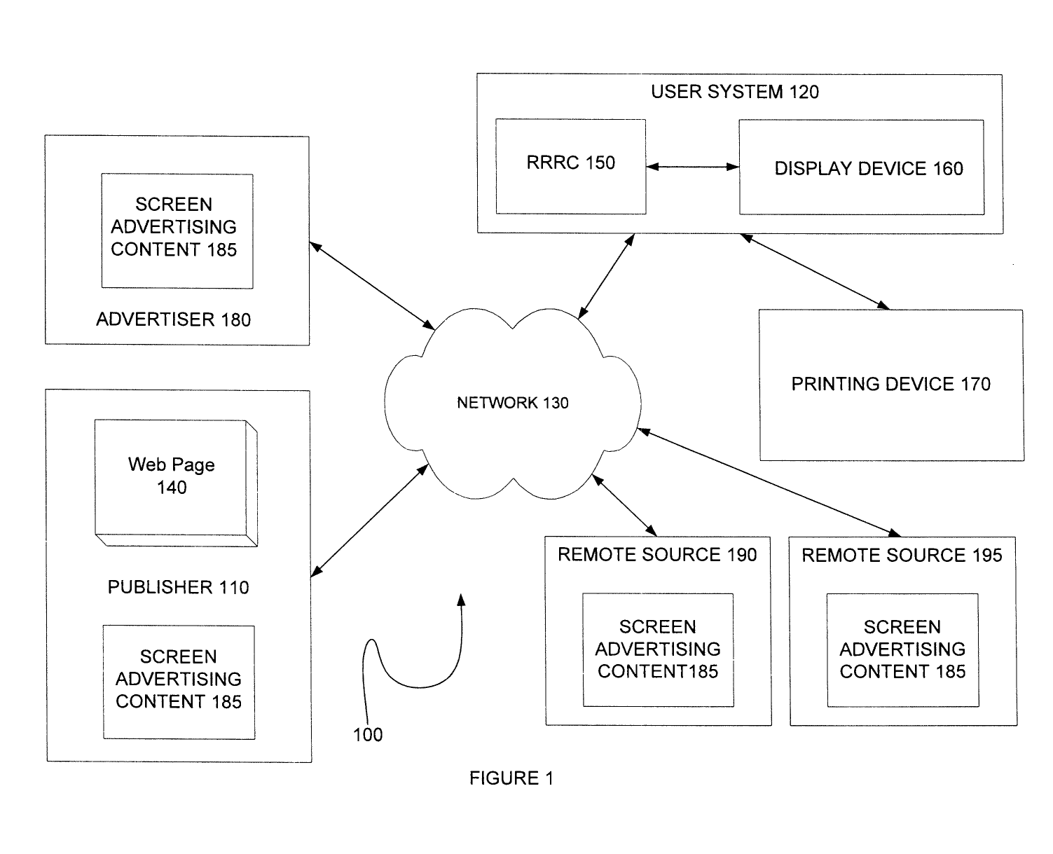

Although there are numerous uses for the invention, a detailed description of at least a first embodiment of the invention is now provided with reference to FIG. 1, which illustrates a schematic representation of an environment 100 that includes a publisher 110, a user system 120 and a communication network 130, which can be, for example, implemented in whole or part by the World Wide Web. In FIG. 1, provisioning of web pages 140 (which may be, for example, but not limited to content included on web pages) is supported by the publisher 110 (e.g., the originator and/or publisher of the web pages). Screen advertising content is stored either at the publisher 110, the advertiser 180, or at one or more remote sources 190, 195. It should be understood that the publisher 110, the advertiser 180, and the remote sources 190, 195 may each be implemented using one or more servers (e.g., one or more server farms, a hierarchically configured server system where a first server acts as a proxy that receives requests from a number of users and routes the requests to appropriate server(s), etc.).

As illustrated in FIG. 1, a user may access the communication network 130 via the user system 120. The user system 120 may include, but is not limited to, a user's computer. The communication network 130 may include, among other things, one or more public networks, such as the Internet, and/or one or more private networks often referred to as “Intranets” and “Extranets.” A connection between the user system 120 and the communication network 130 may be provided by, for example, a company's communication network, an Internet connection via a modem included in the user system 120 and connected to traditional phone lines, an ISDN link, a T1 link, a T3 link, via cable television, via an Ethernet network, etc.; that connection may be made, for example, via a third party, such as an Internet Service Provider (ISP) or wireless network. The connection may be made, for example, either by a direct connection of the client/user to the Internet or indirectly via another, intermediary, device connected to the Internet; in the latter case, the user system 120 may be connected to the intermediary device via a Local or Wide Area Network (LAN or WAN).

A user may access a web page provided by the publisher 110 by establishing a connection, e.g., a TCP connection, between the user system 120 and the publisher 110. The user system 120 may communicate with the publisher 110 using, for example, HTTP protocol over such a TCP connection, to facilitate data transfer between the user system 120 and the publisher 110.

Communication between the publisher 110 and the user system 120 may be facilitated via a Requesting, Receiving and Rendering Component (RRRC) 150, which may be, for example, a browser. Thus, using the RRRC 150, the user system 120 may initiate a request (e.g., HTTP request, TCP/IP request) for a web page 140 from the publisher 110 and render the web page 140 on a display device 160 such as, for example, a laptop screen or computer monitor. Accordingly, the web page 140 may include layout information that dictates how the RRRC 150 controls rendering of the web page's content in a specified layout.

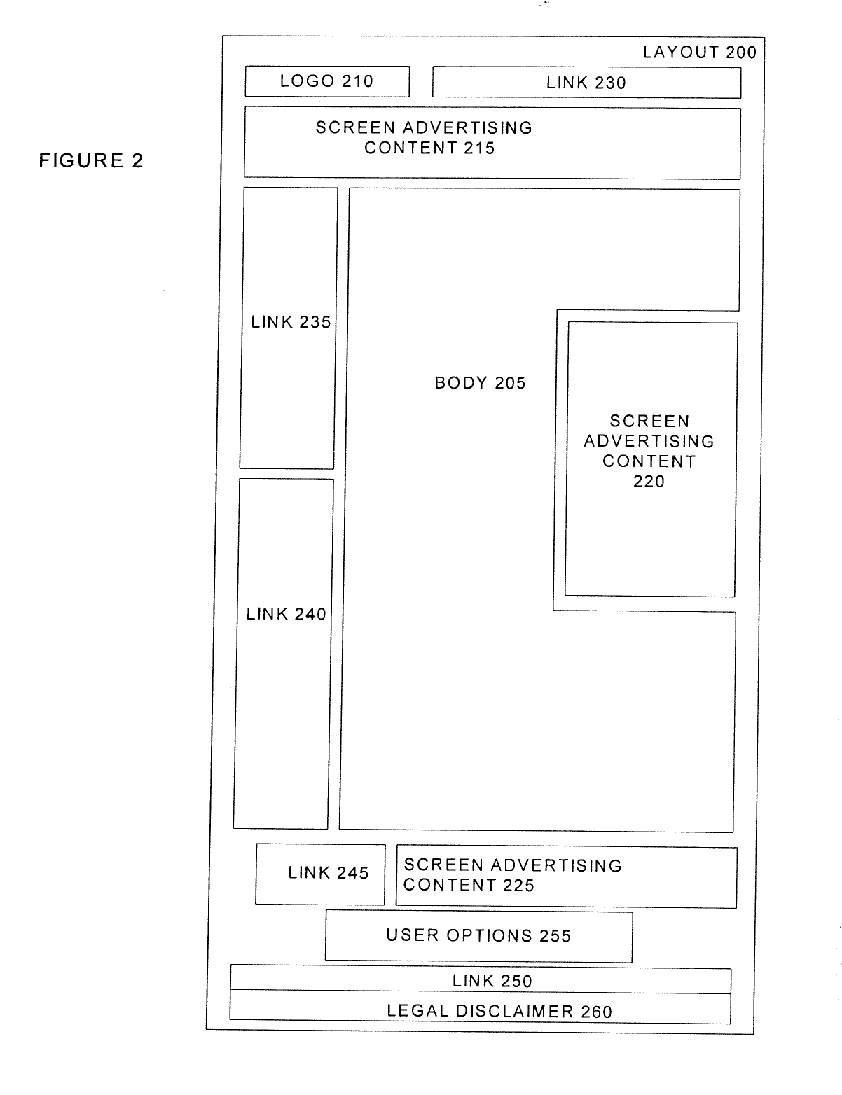

A resulting web page 140 rendered on a display screen 160 may include the publisher's content and screen advertiser content in a format such as that illustrated in FIG. 2. That format includes a layout 200 of various content elements included within the web page. For example, a layout 200 may include pieces of publisher content such as a body 205 (which may consist primarily of text) and various graphical items such as, but not limited to, a company logo 210, navigational URI links 230, 235, 240, 245 and 250, user options 255, and a legal disclaimer 260. In addition the web page consists of various pieces of advertiser content such as screen advertising content 215, 220 and 225.

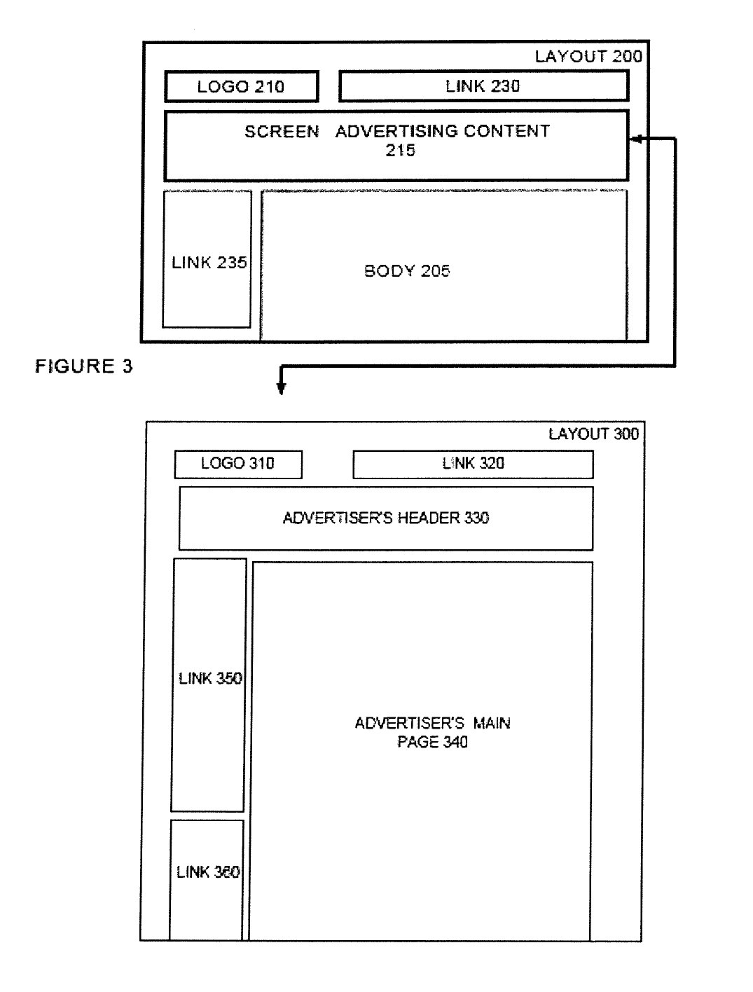

As illustrated in FIG. 3, most screen advertising content is designed to entice the user to activate the screen advertising content. This activation traditionally indicates that the users desires additional information and the URI links located within the screen advertising content instruct the RRRC to request, receive and render the advertiser's web page on the display screen. The advertiser's web page (layout 300) will either replace the user's existing web page (layout 200) or be rendered in a new window in front of the existing web page (layout 200). In many instances, once the advertiser's web page is rendered on the display screen, the user is unable to see the original web page which was visible prior to activating the SAC.

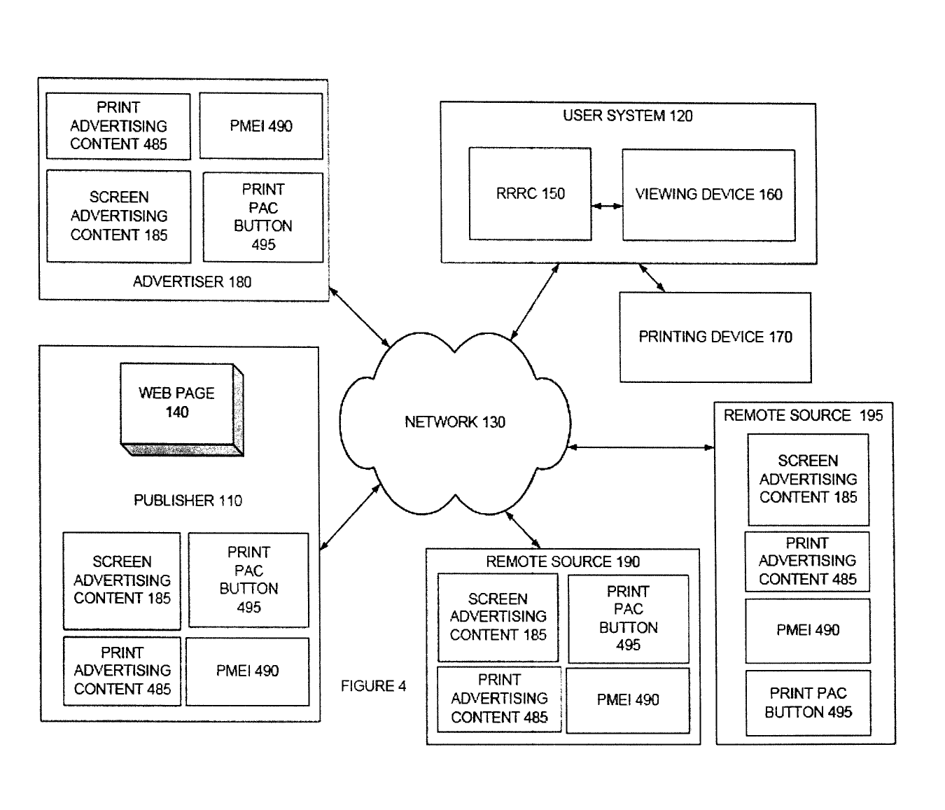

To the contrary, in accordance with various embodiments of the invention (as explained herein) and detailed in FIG. 4, the invention consists of SAC 185, a print PAC button 495, a PMEI 490, and PAC 485. The SAC 185 is a traditional Internet advertisement which is positioned in space sold to the advertiser by the publisher and is placed on a web page 140 which is subsequently requested by a user. Upon the receipt of the web page 140, the screen advertising content 185 may be received from the publisher 110, the advertiser 180, or one, or more, remote sources 190, 195, and is designed to entice the user to click on the screen advertising content 185 for more information. The print PAC button 495 which may be received from the publisher 110, the advertiser 180, or one, or more, remote sources 190, 195, and placed on or next to the screen advertising content is designed for users to receive PAC 485 (e.g., printed information on the advertised product or service, a printed coupon to be redeemed at various stores, a marketing brochure of the advertiser). Unlike the activation of traditional SAC, the activation of a print PAC button 495 results in printing of the PAC 485 without noticeably altering the appearance of the web page on the display device.

Further, the invention includes a PMEI 490 which may be received from the publisher 110, the advertiser 180, or one, or more, remote sources 190, 195, and is designed to function with the print PAC button 495, the screen advertising content 185, and the print advertising content 485. The PMEI 495 includes instructions detailing which PAC 485 is associated with the SAC 185 and, if the print PAC button is activated, from which URI the PAC 485 may be requested if not already obtained and how to render the PAC in the print medium.

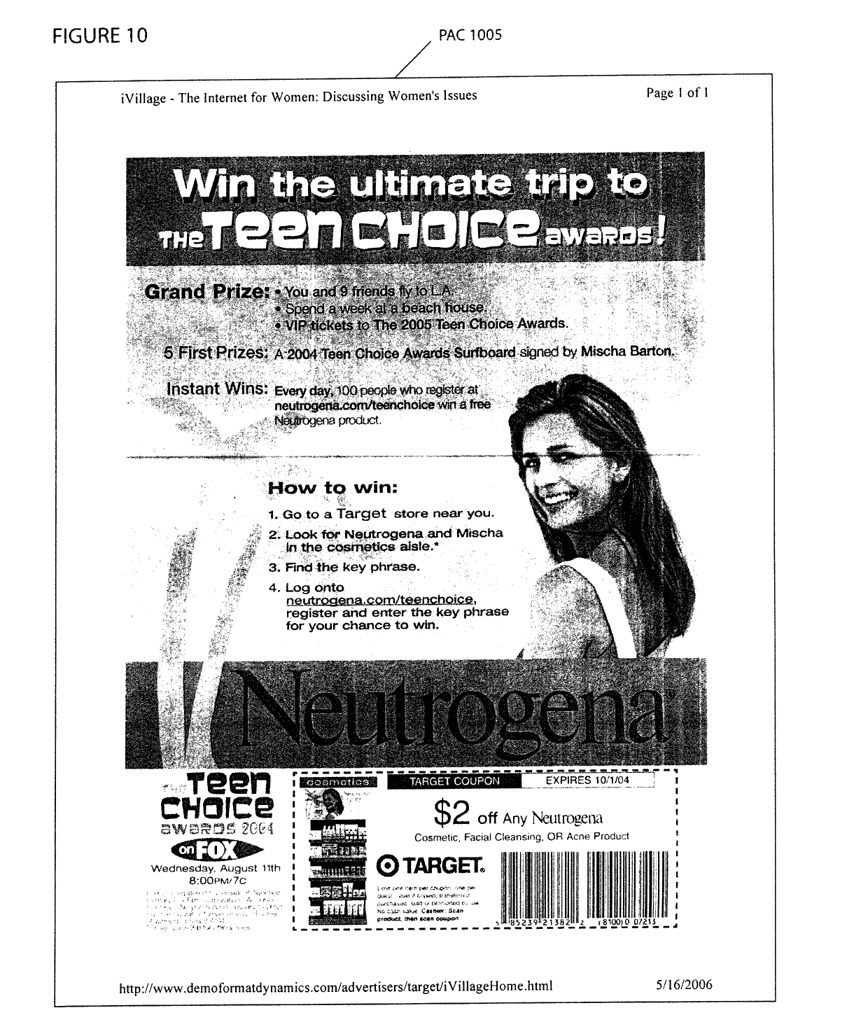

The PMEI 490 includes instructions associated with obtaining and/or utilizing print advertising content that is formulated to be appropriate for a new rendering on a printing device 180. For example, if a user activates a print PAC button 495 positioned on or next to SAC 185, the PMEI 490 automatically obtains, if not already obtained, the appropriate PAC 485. The PMEI may contain instructions to, although unnoticeable to the user, alter the existing web page (e.g., FIG. 2) into one which contains the PAC 485 and is designed for printing. This new layout may hide all of the existing layout, publisher content and advertiser content of the web page and position the print advertiser content 485 in a way that when parsed by the print subroutine, and printed, the resulting printed pages take advantage of the attributes associated with the printed medium (FIG. 10). As illustrated in the figure, there may be, for example, no rendering of any content contained in the original web page.

In accordance with various embodiments of the invention (and as explained herein), a PMEI 490 may be received with SAC 185, a web page 140, a print PAC button 495, or on its own, providing instructions for requesting, receiving, and rendering of PAC 485, associated with the SAC 185, and sent to the printing device 170. The PMEI 490 provides instructions for the RRRC 150 to automatically and effectively request, receive, and render the PAC 485 so that the control software, for example, that control the printing device 170 illustrated in FIG. 1, produces a rendering of the PAC 485 as designed for the print medium. Upon a PAC activation event, the web page rendered on the display screen 160, appears to not have changed and the printing device 170 produces printed pages which only display the PAC 485 (e.g., not the layout and content currently rendered on the display device 160.

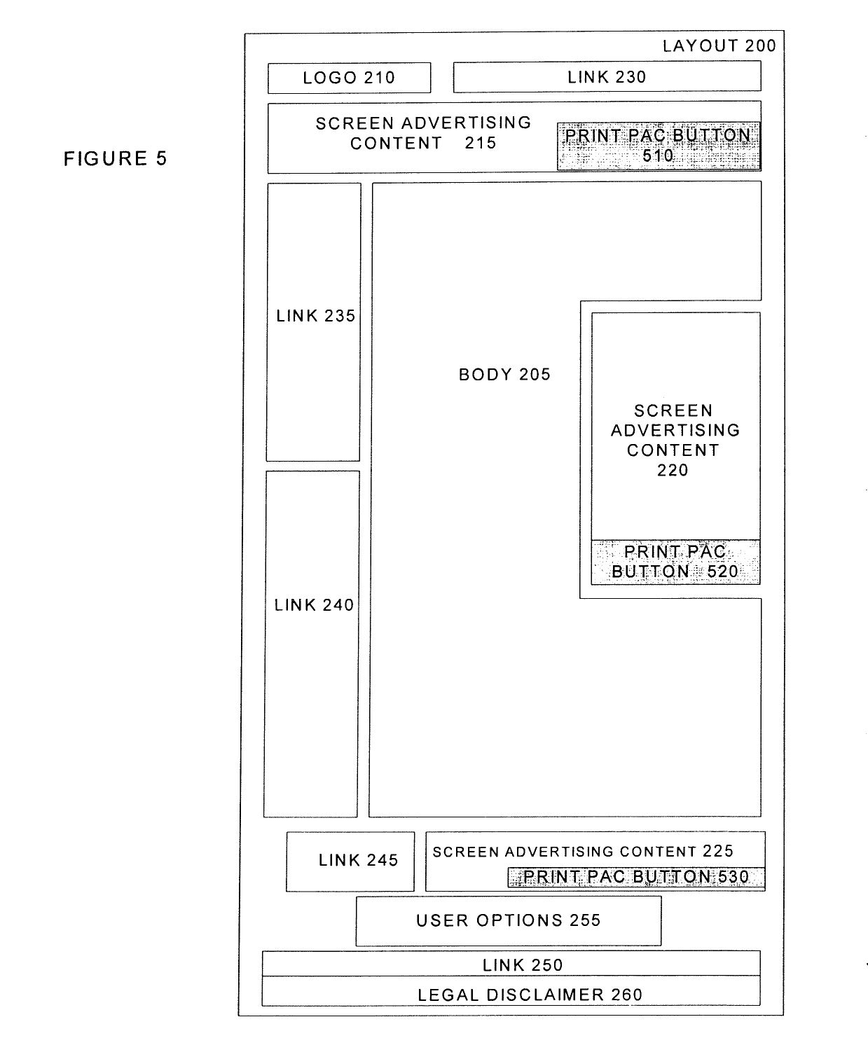

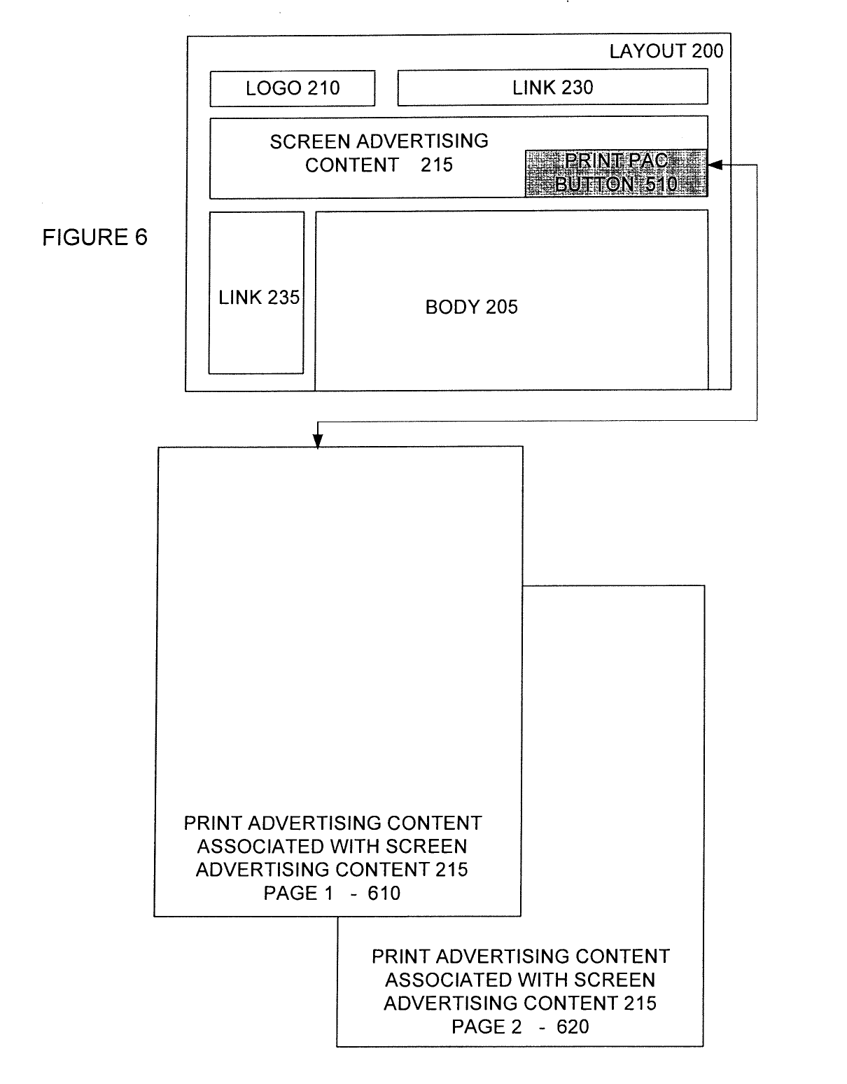

As an example and illustrated in FIG. 5, FIG. 2 has been redesigned with aspects of the current invention. A print PAC button 510, 520, 530 has been positioned on or next to SAC 215, 220, 225. Further, as detailed in FIG. 6, after a user excites or activates the print PAC button 510, the RRRC does not request, receive, and render the advertiser's web page, but rather requests, receives and renders the PAC 610, 620 and forwards the information to the printer without noticeably altering the appearance of the web page (Layout 200) as rendered on the screen.

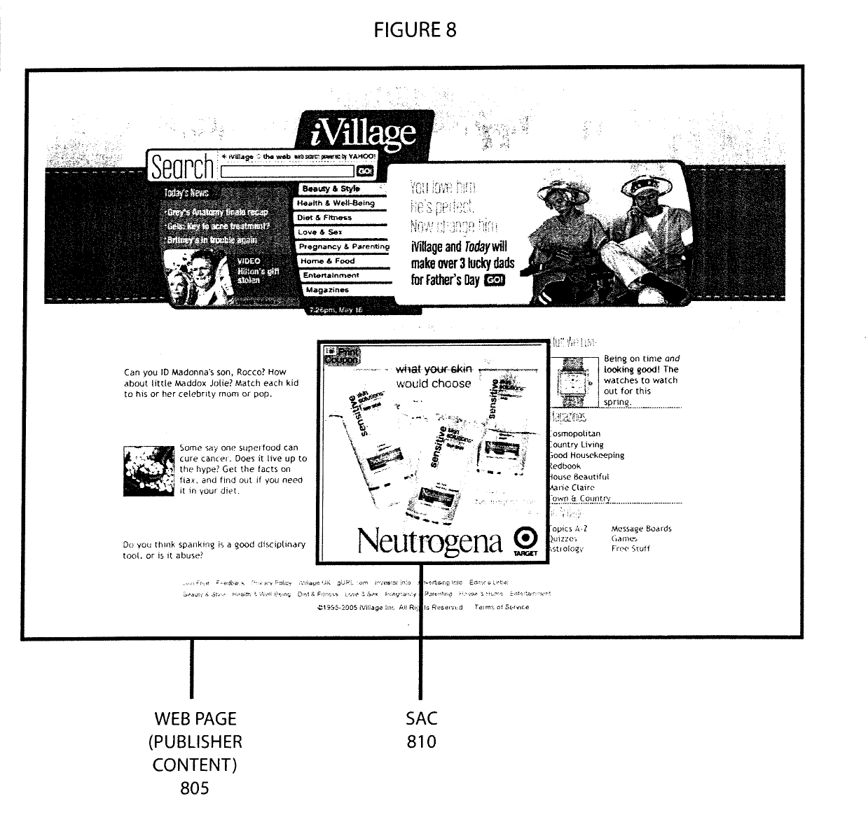

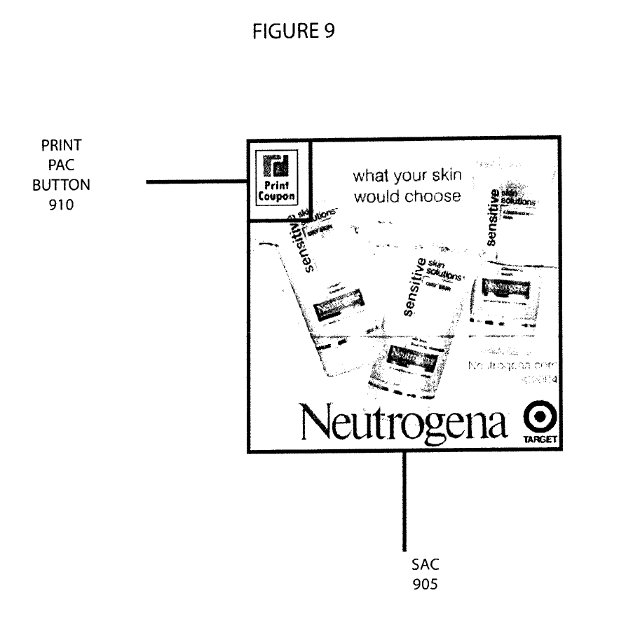

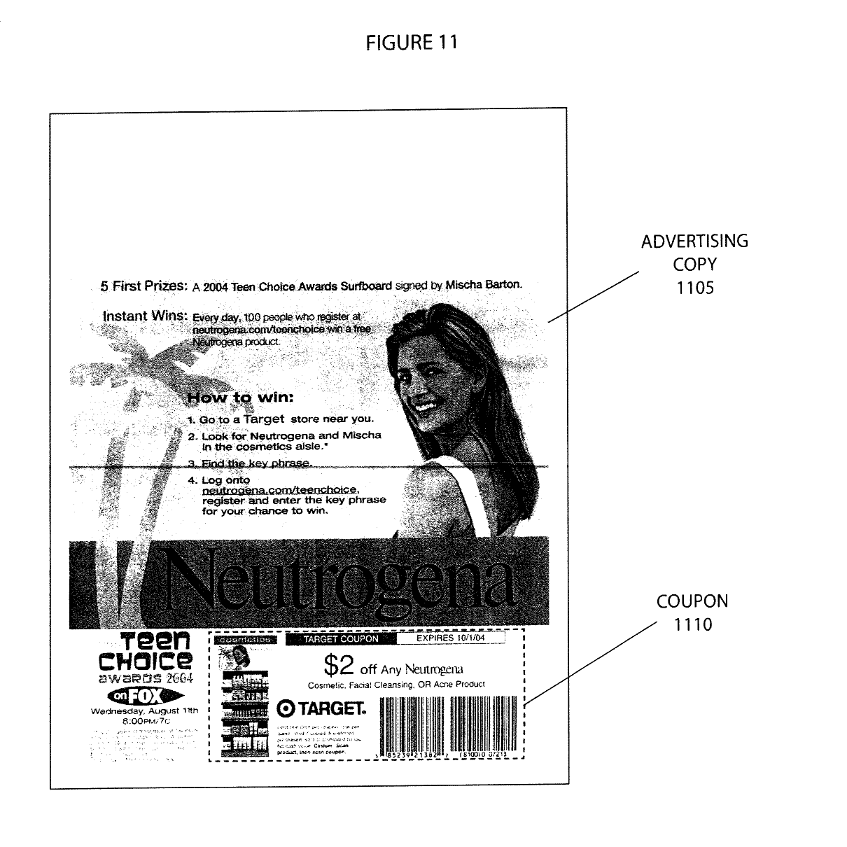

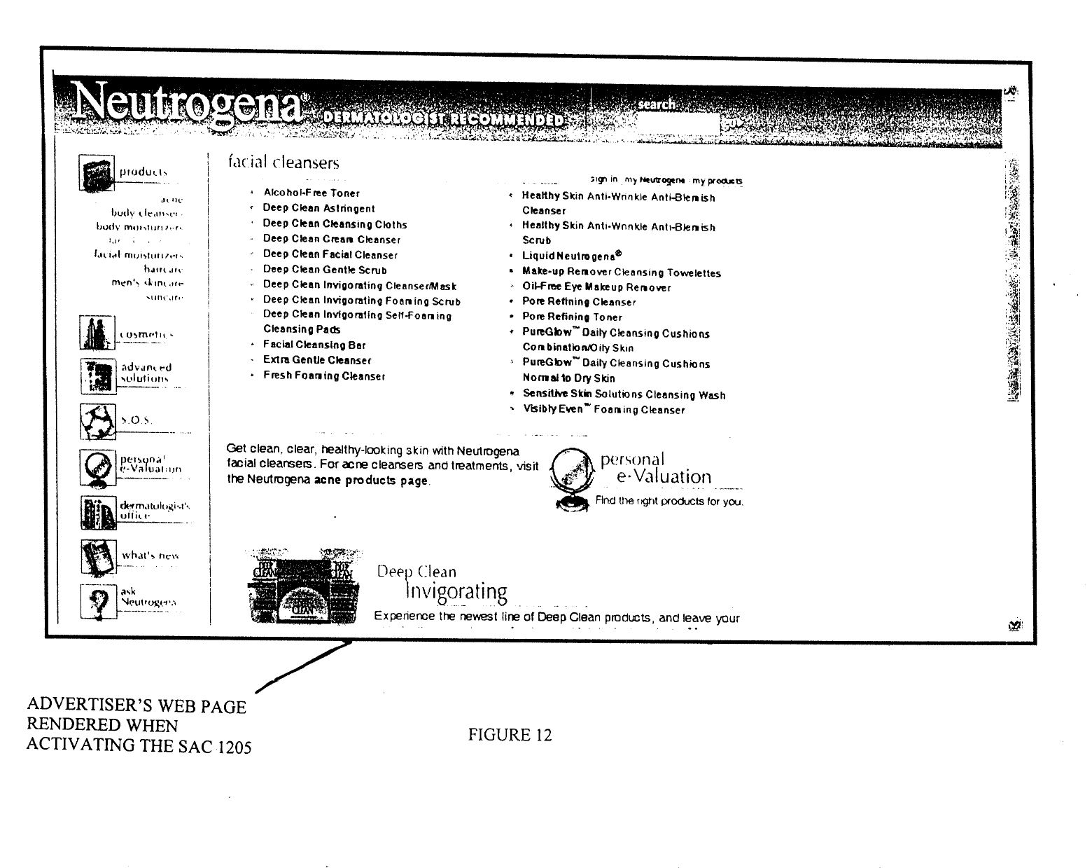

Further examples can be seen in FIG. 8, which depicts a web page on which the publisher has sold the center position of the web page to an advertiser for the placement of SAC 810. The page consists of publisher content 805 and advertiser content 810. In addition, FIG. 9 details SAC 905 from FIG. 8 and a print PAC button 910 positioned in the upper left corner of the SAC 905. If a user activates or excites the print PAC button 910, the RRRC requests, receives, renders and forwards to the printing device the associated PAC 1005 as detailed in FIG. 10. Since PAC 1005 is printed on 8.5 inch by 11 inch paper, FIG. 11 illustrates the amount of space an advertiser has to relay their message. This example not only contains a coupon 1110 directing a user to a specific store, but a significant amount of space for advertising copy 1105 detailing a promotion which the advertiser is conducting. FIG. 12 illustrated the advertiser's web page 1205 which is requested, received and render on the viewing device if the user activates or excites the SAC 905 instead of the print PAC button 910. In this instance, the advertiser's web page 1205 would be rendered in place of the web page the user was viewing or rendered in a new window in front of the web page the user was viewing.

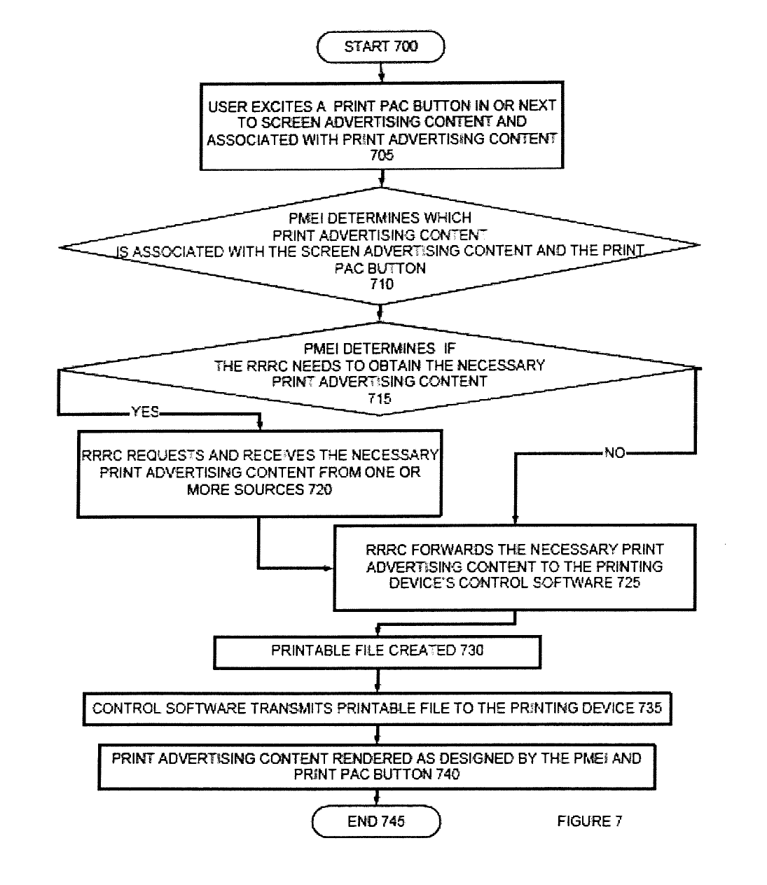

Therefore, as illustrated in FIG. 7, various operations occur following the user activating an event which sends PAC (i.e., print information for an advertised product or service) to a printing device (i.e., a PAC print event). The operations begin at 700 and control proceeds to 705 where a user excites a print PAC button associated with PAC related to SAC. Control proceeds to 710, at which, the PMEI uses the information associated with the print PAC button to determine the appropriate PAC which is associated with the SAC and should be printed. Control proceeds to 715 where the PMEI determines if the necessary PAC needs to be obtained or has already been obtained. If already obtained control proceeds to 725. If the necessary PAC needs to be obtained control proceeds to 720 at which point the RRRC (through, but not limited to, URI links associated with the SAC, print PAC button, or PMEI) obtains the appropriate PAC (for example, by communicating with the publisher, the advertiser, or with one, or more, remote sources (e.g., one or more servers or server systems). Subsequently, once all the information is received, control proceeds to 725, at which point the PMEI instructs the RRRC to alter, if necessary, the web page given the new information and transmit the altered web page to the control software associated with the printing device and control proceeds to 730. At 730, the control software for the printing device determines how to parse and render the PAC according to the software associated with the printing device (e.g., a print subroutine and printer driver) and a render-able file may be created. Control then proceeds to 735, at which point the render-able file may be forwarded to the printing device for rendering. Subsequently, at 740, the printing device receives the information and renders the PAC in the print medium, e.g., printed product information, brochures and/or coupons associated with the onscreen Internet advertisement. Control then proceeds to 745, at which operations associated with processing the event ends.

It should be understood that, upon, or subsequent to, the process of at least the first embodiment of the invention, control may proceed to implement operations associated with the second embodiment (explained herein) prior or subsequent to 725.

It should also be understood that immediately upon forwarding the newly rendered web page to the control software associated with the second rendering device 735, the PMEI can hide the PAC, if displayed on the first rendering device, and unhide, or display, all of the components of the original web page (e.g., layout, content and additional information). As a result, it may appear to the user as if the web page viewed on the display device has gone unchanged as the change to the new version and the change back to the old version may be so rapid that the web page on the screen appears to never have been performed.

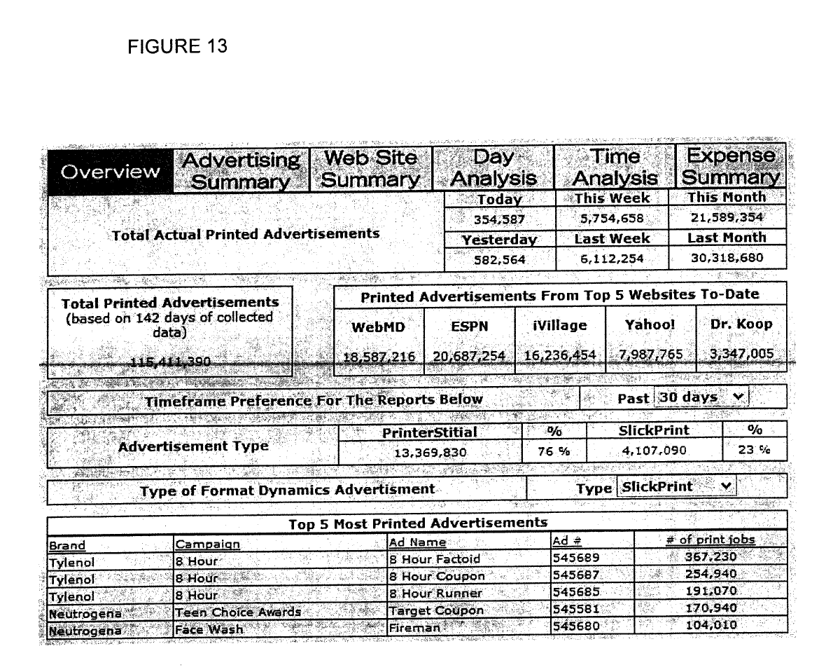

In accordance with at least a second embodiment of the invention, a method and system are provided for tracking the usage of each of the other embodiments. The same operations that allow digital documents to be altered in each of embodiments, may enable notification upon the activation of or subsequent to a Print activation event described in the PMEI and/or recordation of all types of request and activation events (including, but not limited to the embodiments listed above). Thus, in accordance with at least the second embodiment of the invention, web page providers and advertisers may be provided with reports on, but are not limited to, what and how often content and PACs have been rendered, e.g., how many PACs were printed from the system over a variety of time frames, the additional exposure which could be obtained if they apply a print PAC button on or next to each of their SAC, printed SAC, the hourly, daily, weekly and monthly display and printing totals, estimates on their annual number of displayed and printed web pages and PACs, the top 100 most rendered (e.g., displayed or printed) web pages and PACs given a variety of time frames and upon each Print activation event, a collection of information relating to what PAC was rendered, a time and date of each rendering, an Internet Protocol address of a computer rendering the PAC, the type of RRRC which was in use, and, depending on the PAC rendered, the city, state, country, market area of the user. Similar information can be collected for request events. FIG. 13 includes an exemplary format of a data report generated by such tracking.

Moreover, in accordance with at least this embodiment of the invention, information may be recorded that indicates what PAC has been rendered, how it has been rendered (i.e., using what medium). Thus, the operations and functionality of the second embodiment may be combined with any of the remaining embodiments to allow tracking of PAC rendering.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that various implementations of the invention may be provided wherein, print advertising content may be displayed very briefly, e.g., for a period of time such that it is unnoticeable to the user viewing a webpage. Alternatively, the print advertising content may be printed without being first displayed on a viewing device.

What is claimed is:

1. A method of creating screen advertising content for use by an advertiser and unassociated with a web site on which the screen advertising content is to be placed, the screen advertising content including printing machine executable instructions, the method comprising:
placing an icon on or next to the screen advertising content on a web page;
in response to a user activating the icon, implementing the printing machine executable instructions, which automatically requests and receives, if not already obtained, print advertising content, which has been created for use by the advertiser and is unassociated with the web site or the web page on which the screen advertising content is placed; and
forwarding the print advertising content to a printer, regardless of a printer type, while continuing instructions to continue rendering of the screen advertising content on the web page.

2. The method of claim 1, wherein the advertiser pays the unassociated web site for the placement of its screen advertising content.

3. The method of claim 1, wherein the advertiser barters with the unassociated web site for the placement of its screen advertising content.

4. The method of claim 1, wherein the advertiser receives placement of its screen advertising content for free from the unassociated web site.

5. The method of claim 1, wherein the icon is a print print advertising content icon.

6. The method of claim 1, wherein the activation of the print print advertising icon is a print activation event.

7. The method of claim 1, wherein the print advertising content is designed for the printed page and comprises and brochures, coupons.

8. The method of claim 1, wherein the screen advertising content is designed for the placement on web pages.

9. The method of claim 1, wherein the screen advertising content is served by the publisher's serving system upon a web page being requested by a user.

10. The method of claim 1, wherein the screen advertising content is served by the advertiser's serving system upon a web page being requested by a user.

11. The method of claim 1, wherein the screen advertising content is served by one, or more, remote sources upon a web page being requested by a user.

12. The method of claim 1, wherein the print print advertising icon is served by the publisher's serving system.

13. The method of claim 1, wherein the print print advertising icon is served by the advertiser's serving system.

14. The method of claim 1, wherein the print print advertising icon is served by one, or more, remote sources.

15. The method of claim 12, wherein the print print advertising content icon is served by the publisher's serving system prior to the screen advertising content being served.

16. The method of claim 12, wherein the print print advertising content icon is served by the publisher's serving system with the screen advertising content being served.

17. The method of claim 12, wherein the print print advertising content icon is served by the publisher's serving system after the screen advertising content has been served.

18. The method of claim 13, wherein the print print advertising content icon is served by the advertiser's serving system prior to the screen advertising content being served.

19. The method of claim 13, wherein the print print advertising content icon is served by the advertiser's serving system with the screen advertising content being served.

20. The method of claim 13, wherein the print print advertising content icon is served by the advertiser's serving system after the screen advertising content has been served.

21. The method of claim 14, wherein the print print advertising content icon is served by the one, or more, remote sources prior to the screen advertising content being served.

22. The method of claim 14, wherein the print print advertising content icon is served by the one or more remote sources with the screen advertising content being served.

23. The method of claim 14, wherein the print print advertising content icon is served by one, or more, remote sources' serving system after the screen advertising content has been served.

24. The method of claim 1, wherein the printing machine executable instructions are served by the publisher's serving system.

25. The method of claim 1, wherein the printing machine executable instructions are served by the advertiser's serving system.

26. The method of claim 1, wherein the printing machine executable instructions are served by one, or more, remote sources.

27. The method of claim 24, wherein the printing machine executable instructions are served by the publisher's serving system prior to the screen advertising content.

28. The method of claim 24, wherein the printing machine executable instructions are served by the publisher's serving system with the screen advertising content.

29. The method of claim 24, wherein the printing machine executable instructions are served by the publisher's serving system after the screen advertising content.

30. The method of claim 25, wherein the printing machine executable instructions are served by the advertiser's serving system prior to the screen advertising content.

31. The method of claim 25, wherein the printing machine executable instructions are served by the advertiser's serving system with the screen advertising content.

32. The method of claim 25, wherein the printing machine executable instructions are served by the advertiser's serving system after the screen advertising content.

33. The method of claim 26, wherein the printing machine executable instructions are served by one, or more, remote sources' prior to the screen advertising content.

34. The method of claim 26, wherein the printing machine executable instructions are served by one, or more, remote sources' serving system with the screen advertising content.

35. The method of claim 26, wherein the printing machine executable instructions are served by one, or more, remote sources' after the screen advertising content.

36. The method of claim 1, wherein the printing machine executable instructions include information for obtaining print advertising content.

37. The method of claim 36, wherein the print advertising content is served by the publisher's serving system prior to a print activation event.

38. The method of claim 36, wherein the print advertising content is served by the publisher's serving system upon a print activation event.

39. The method of claim 36, wherein the print advertising content is served by the advertiser's serving system prior to a print activation event.

40. The method of claim 36, wherein the print advertising content is served by an advertiser's serving system upon a print activation event.

41. The method of claim 36, wherein the print advertising content is served by one, or more, remote sources' server systems prior to a print activation event.

42. The method of claim 36, wherein the print advertising content is served by one, or more, remote sources' server systems upon to a print activation event.

43. The method of claim 1, wherein prior to, upon, or after a print print advertising content icon is activated, the printing machine executable instructions forwards information regarding a print activation event comprising the web site, the web page, the screen advertising content, the print advertising content, a time and date of activation, a user's IP address, an advertiser paying for the advertisement, a location on the screen of the screen advertising content, and a location of the print print advertising content icon.

44. The method of claim 43, wherein the printing machine executable instructions forwards information about the print activation event prior to the user activating a print print advertising icon.

45. The method of claim 43, wherein the printing machine executable instructions forwards information about the print activation event upon the user activating a print print advertising icon.

46. The method of claim 43, wherein the printing machine executable instructions forwards information about the print activation event after the user activates a print print advertising icon.

47. The method of claim 43, wherein the printing machine executable instructions forwards information about the print activation event to the publisher.

48. The method of claim 43, wherein the printing machine executable instructions forwards information about the print activation event to the advertiser.

49. The method of claim 43, wherein the printing machine executable instructions forwards information about the print activation event to one, or more, remote sources.

50. The method of claim 43, wherein the information collected by one, or more, remote sources regarding the print activation event is detailed in reports provided to the publisher.

51. The method of claim 43, wherein the information collected by one, or more, remote sources regarding the print activation event is detailed in reports provided to the advertiser.

52. The method of claim 43, wherein the information collected by the publisher, advertiser, or one, or more, remote sources regarding the print activation event can be aggregated and sold or given to additional parties.
